(19) United States
(12) Patent Application Publication
(10) Pub. No.: US 2014/0124268 A1
(43) Pub. Date: May 8, 2014

(54) CV Joint for Down Hole Motor and Method

(71) Applicant: Innovative Drilling Motors, LLC, Broussard, LA (US)

(72) Inventor: Clyde J. Breaux, Lafayette, LA (US)

(21) Appl. No.: 13/670,539

(22) Filed: Nov. 7, 2012

(51) Int. Cl. E21B 7/04; F16D 3/72

(52) U.S. Cl. CPC E21B 7/04; F16D 3/72
USPC 175/61; 464/155

(57) ABSTRACT

An apparatus for transmitting torque to a down hole motor in a down hole drilling assembly. The apparatus includes a center rod having a distal protuberance and a proximal protuberance, a transmission adapter having a first end connected to the down hole motor, and a transmission socket formed within a second end of the transmission adapter and configured to receive the proximal protuberance. The apparatus may also include a bearing adapter operatively connected to the center rod, with the bearing adapter having a bearing socket therein, and wherein the transmission adapter is configured to connect to an output of the down hole motor and the bearing adapter is configured to connect to an input of a bearing assembly in the down hole assembly for drilling the well. A method of drilling a well is also disclosed.

### BACKGROUND OF THE INVENTION

This invention relates to down hole motors used in drilling oil and gas wells. More particularly, but not by way of limitation, this invention relates to a CV joint for a transmission used with down hole motors.

As the energy industry seeks new reserves, operators are drilling wells that are highly deviated and in many cases horizontal. The wells can be very deep and the speed in which wells are drilled is critical. The drill strings require highly complex designs and must withstand substantial torque, strain and weight, as well understood by those of ordinary skill in the art.

Prior art down hole motors require a constant velocity (“CV”) joint (sometimes referred to as universal joints) for the rotary transmission to the attached drill bit. See U.S. Pat. No. 4,772,246 to Wenzel, entitled “Downhole Motor Drive Shaft Universal Joint Assembly” which is incorporated in its entirety herein by express reference. In the event of a failure of the CV joint, drilling must be ceased and the entire drill string is pulled from the well for proper maintenance and/or repair.

### SUMMARY OF THE INVENTION

An apparatus for transmitting torque to a down hole motor in a down hole drilling assembly is disclosed. In one embodiment, the apparatus may comprise a center rod having a distal protuberance and a proximal protuberance, with the proximal protuberance having a female insert therein, and a male post operatively configured to engage the female insert. The apparatus may also include a transmission adapter having a first end connected to the down hole motor and a socket profile formed within the second end of the transmission adapter and configured to receive the proximal protuberance. The apparatus may include an adapter cap threadedly connected to thread means located on the transmission adapter, a cap split ring sub abutting the proximal protuberance and a cap split ring fitted into said adapter cap and configured to engage the cap split ring sub.

In one preferred embodiment, the transmission adapter is configured to connect to a rotary output of a down hole motor so that the socket profile is rotated which is transmitted to the center rod. A bearing adapter, operatively connected to the center rod, may be included, wherein the bearing adapter is configured to connect to an input of a bearing assembly in the down hole assembly. In one embodiment, the male post has a first and a second end, wherein the second end has a spherical member operatively connected to the proximal protuberance and the first end is connected to the transmission adapter. In one preferred embodiment, the female insert comprises a cylindrical member with a convex surface configured to engage the spherical member of the male post. The apparatus may also include a second male post operatively configured to engage a second female insert positioned within the distal protuberance. A second adapter cap may also be included, wherein the second adapter cap is threadedly connected to a second thread means of the bearing adapter. The apparatus may also comprise a cap split ring sub abutting the proximal protuberance and a cap split ring fitted into the adapter cap and configured to engage the cap split ring sub.

A method of drilling a well with a down hole motor is also disclosed. The method includes providing an apparatus in the well, wherein the apparatus comprises: a center rod having a distal protuberance and a proximal protuberance, a transmission adapter having a first end connected to the down hole motor; a socket formed within a second end of the transmission adapter and configured to receive the proximal protuberance; an bearing adapter operatively connected to the center rod, the bearing adapter having a bearing socket therein; wherein the transmission adapter is configured to connect to an output of the down hole motor and the bearing adapter is configured to connect to an input of a bearing assembly in the down hole assembly. The method includes flowing a drilling fluid through the down hole motor which in turn rotates the output of the down hole motor wherein the output is connected to the transmission adapter and engaging the proximal protuberance of the center rod with the transmission socket in the transmission adapter. The method includes engaging the distal protuberance of the center rod with the bearing socket in the bearing adapter, and rotating the center rod, the first protuberance and the second protuberance. The method may further comprise rotating the bearing assembly operatively associated with the bearing protuberance, wherein the bearing assembly is attached to a drill bit so that the drill bit is rotated and the well is drilled.

### BRIEF DESCRIPTION OF THE DRAWINGS

FIG. 1 is a front view of the present CV joint apparatus.

FIG. 2 is a cross-sectional view of the CV joint apparatus seen in FIG. 1 taken along line A-A.

FIG. 3 is an exploded view of the CV joint apparatus seen in FIG. 2.

FIG. 4 is a perspective, cross-sectional view of the CV joint apparatus seen in

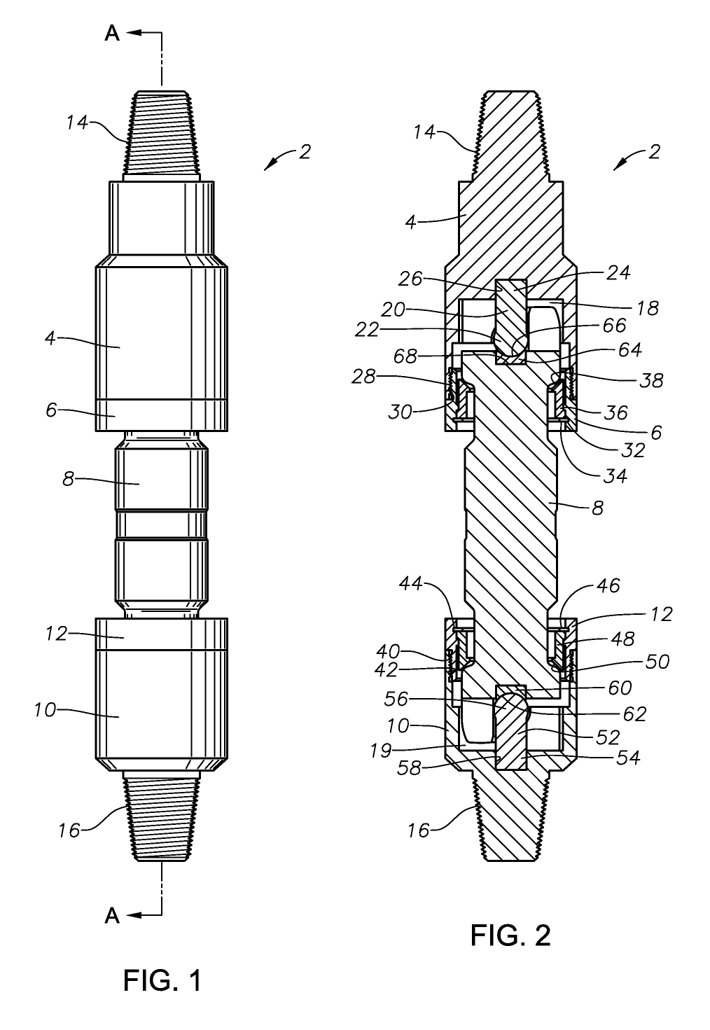

FIG. 1 taken along line A-A.

FIG. 5 is a schematic view of the CV joint apparatus used in a drill string for drilling a well.

### DETAILED DESCRIPTION OF THE PREFERRED EMBODIMENTS

Referring now to FIG. 1, a front view of the present CV joint apparatus 2 will now be described. The apparatus 2 includes the transmission adapter 4 that is attached to the adapter cap 6, also referred to as the retainer 6. The apparatus 2 includes the center rod 8 that is operatively attached to transmission adapter 4 as will be more fully explained. The center rod 8 is also operatively attached to the bearing adapter 10, wherein the bearing adapter 10 is attached to the adapter cap 12, also referred to as the retainer 12. The bearing adapter 10 is operatively attached to the center rod 8 as will be more fully set-out later in the application. As seen in FIG. 1, the transmission adapter 4 contains thread means 14 for threadedly engaging with the output of a down hole motor (not seen here). Down hole drilling motors are commercially available from Innovative Drilling Motors, LLC under the name drilling motors. The bearing adapter 10 will contain thread means 16 for threadedly engaging with the bearing assembly (not seen here) of a down hole motor.

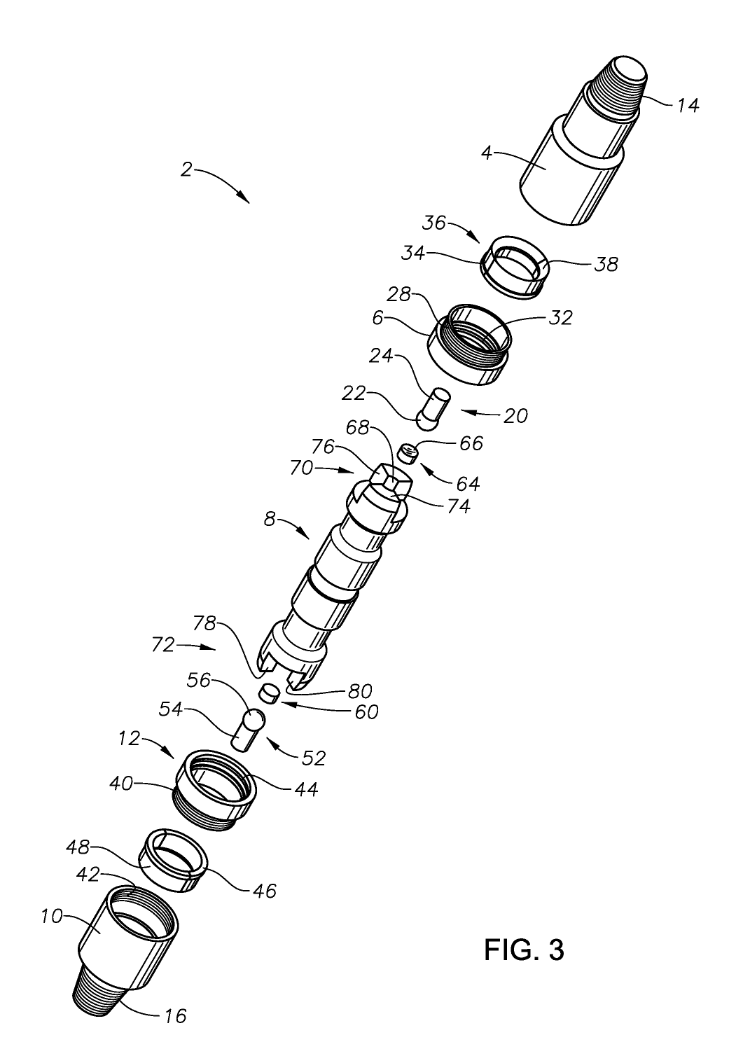

FIG. 2 is a cross-sectional view of the apparatus 2 seen in FIG. 1 taken along line A-A. It should be noted that like numbers appearing in the various figures refer to like components. The transmission adapter 4 contains a socket profile seen generally at 18 as well as socket profile seen generally at 19 of the bearing adapter 10 that will receive the ends of the center rod 8, which will be described later in the application. FIG. 2 also depicts a male post 20 that contains a first spherical end 22 and a second cylindrical end 24, wherein the cylindrical end 24 is received within bore 26 of the transmission adapter 4.

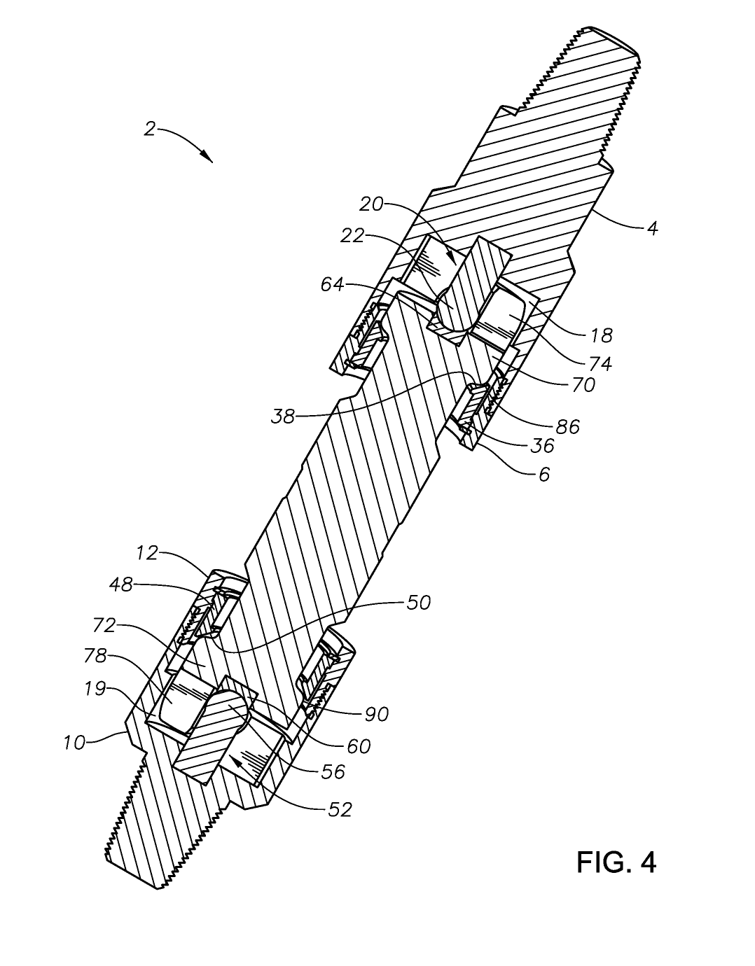

FIG. 2 also depicts the adapter cap 6 that has an outer portion containing outer thread means 28 that will threadedly engage with inner thread means 30 of the transmission adapter 4. On inner portion of the adapter cap 6, a groove 32 is provided, wherein groove 32 will receive the split ring 34. Split rings are commercially available from Innovative Drilling Motors, LLC under the name split rings. As seen in FIG. 2, the split ring 34 will abut the split ring sub 36 to hold the split ring sub 36 in place. The split ring sub 36 contains a chamfered surface 38 that cooperates and engages with a complementary shoulder of the center rod 8, which will be described later in the application. FIG. 2 also depicts the adapter cap 12 that has an outer portion containing outer thread means 40 that will threadedly engage with inner thread means 42 of the transmission adapter 4. On inner portion of the retainer 12, a groove 44 is provided, wherein groove 44 will receive the split ring 46. As seen in FIG. 2, the split ring 46 will abut the split ring sub 48 to hold the split ring sub 46 in place. The split ring sub 48 contains a chamfered surface 50 that cooperates and engages with a complementary shoulder of the center rod 8, which holds the center rod 8 in an engaged position relative to the bearing adapter 10. In the preferred embodiments, the split ring subs 36, 48 are each separated into two (2) halves (as illustrated in FIG. 3).

FIG. 2 also depicts the male post 52 that contains the cylindrical part 54 that extends to the spherical end 56, with the cylindrical part 54 fitting into an inner bore 58 of the bearing adapter 10. The spherical end 56 engages and cooperates with the female insert 60, with the female insert 60 having a convex surface 62 configured for engagement with the spherical end 56. The spherical end 22 also engages and cooperates with the female insert 64, with the female insert 64 having the convex surface 66 configured for engagement with the spherical end 22.

Referring now to FIG. 3, an exploded view of the CV joint apparatus 2 seen in FIG. 2 will now be described. The transmission adapter 4, with external thread means 14 is shown, along with the split ring sub 36 which is operatively associated with the split ring 34. Also shown is the adapter cap 6 with outer thread means 28 which will engage with internal threads 30 (not seen in this view) of the transmission adapter 4. The split ring sub 36 will cooperate and engage with the adapter cap 6 as previously discussed. FIG. 3 also depicts the male post 20, wherein the spherical end 22 will cooperate and engage the convex surface 66 of the female insert 64.

The female insert 64 is seated within the center rod 8 at 68 as seen in FIGS. 2 and 3. As seen in FIG. 3, the center rod 8 has a first protuberance seen generally at 70 and a second protuberance seen generally at 72. More specifically, the first protuberance 70 has a first prong 74 and a second prong 76; the second protuberance 74 has a first prong 78 and a second prong 80. The prongs 74, 76 will cooperate and engage with the socket 18 formed within the transmission adapter 4 and the prongs 78, 80 will cooperate and engage with the socket 19 formed within the bearing adapter 10 for transmission of the torque. The sockets 18, 19 are cavities that act as the receptacle for the protuberances 70, 72. Hence, the sockets 18, 19 are reciprocally formed relative to the protuberances 70, 72 similar to a tongue and groove arrangement.

As seen in FIG. 3, the bearing adapter 10 has the external thread means 16 for making up with the bearing assembly (not seen in this view). The split ring sub 48 will cooperate and engage with the adapter cap 12, and the adapter cap 12 will threadedly connect via outer threads 40 to the inner threads 42 of the bearing adapter 10. The split ring sub 48 is operatively associated with the split ring 46, wherein the split ring 46 is positioned in the groove 44 of the adapter cap 12, with the split ring 46 abutting the split ring sub 48 to hold the split ring sub 48 in place. FIG. 3 further depicts the male post 52, and wherein the spherical end 56 will engage and cooperate with the convex surface of the female insert 60.

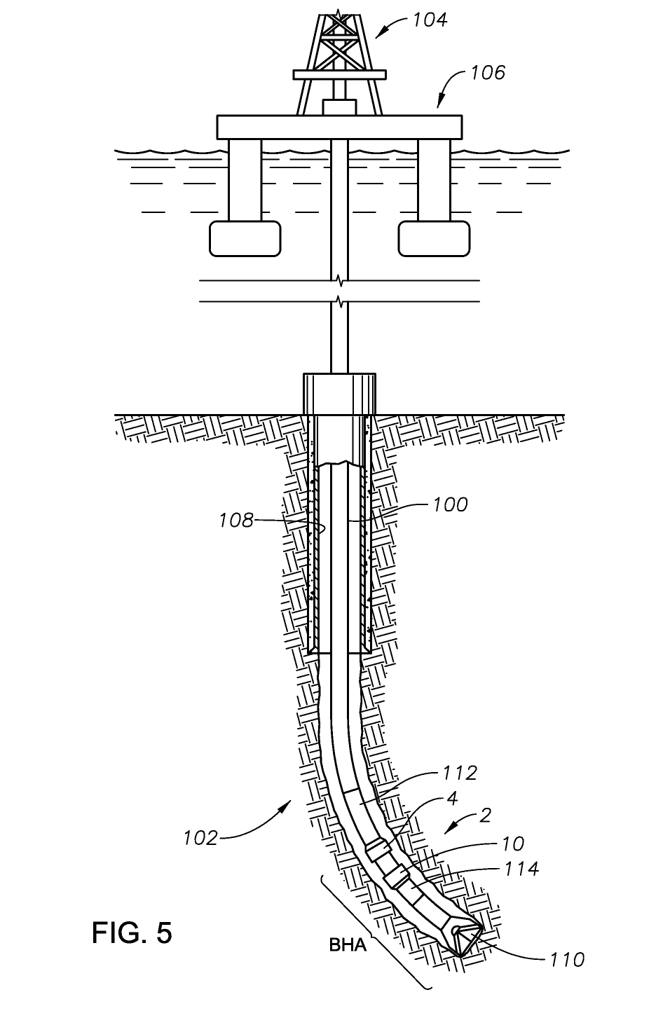

FIG. 4 is a perspective, cross-sectional view of the CV joint apparatus 2 seen in FIG. 1 taken along line A-A. FIG. 4 depicts the prong 74 of the protuberance 70, wherein the prong 74 is received within the socket 18 of the transmission adapter 4. The socket 18 is a receptacle for the prongs 74, 76 and are configured to receive the prongs 74, 76 as noted earlier. Also, the beveled shoulder 86 of the protuberance 70 cooperates and engages with the chamfered surface 38 of the split ring sub 36. FIG. 4 depicts the prong 78 of the protuberance 72, wherein the prong 78 is received within the socket 19 of the bearing adapter 10. The socket 19 is a receptacle for the prongs 78, 80 and are configured to receive the prongs 78, 80 as noted earlier. Also, the beveled shoulder 90 of the protuberance 72 cooperates and engages with the chamfered surface 50 of the split ring sub 48. Note that the snap rings are not shown in this view.

Referring now to FIG. 5, a schematic view of the CV joint apparatus 2 used in the drill string 100 for drilling a well 102. The schematic shows the a drilling rig 104 on a floating platform 106 in offshore waters. A string of casing 108 has been set and the well continues to be drilled with the bit 110. The bit 110 is operatively attached to a bottom hole drill assembly (BHA) that includes a down hole motor 112, the apparatus 2, and the bearing assembly 114. FIG. 5 depicts the transmission adapter 4 connected to the output of the down hole motor 112, the bearing adapter 10 being connected to the bearing assembly 114, and the bit 110 drilling ahead.

In operation, and referring collectively to FIGS. 1-5, the operator provides the apparatus 2 within the well 102 via the drill string 100. A drilling fluid is pumped through the down hole motor 112 which will cause an output shaft to rotate, which in turn engages the male post with the proximal protuberance 70. The center rod 8 is rotated via the proximal protuberance 70 being rotated via the socket 18 within the transmission adapter 4, which in turn engages the distal protuberance 72 with the socket 19, which in turn will rotate the bearing adapter 10. This in turn causes the rotation of the bearing assembly 114 and the well 102 is drilled by the bit 110.

An aspect of this embodiment is that prior art ball bearings and ball seats are not utilized. Ball bearings can wear out ball seats, and ball bearings may fail due to fatigue, loads and/or strain. An aspect of this invention is that in the event that one of the protuberance fails, the adjacent protuberance located on the center rod will be able to transfer the transmitted torque so that the bit continues to drill the well.

Although the present invention has been described in considerable detail with reference to certain preferred versions thereof, other versions are possible. Therefore, the spirit and scope of the appended claims should not be limited to the description of the preferred versions contained herein.

I claim:

1. An apparatus for transmitting torque to a down hole motor of a down hole drilling assembly comprising:
a center rod having a distal protuberance and a proximal protuberance, said proximal protuberance having a female insert therein;
a male post operatively configured to engage said female insert;
a transmission adapter having a first end connected to the down hole motor;
a socket profile formed within a second end of said transmission adapter and configured to receive said proximal protuberance.

2. The apparatus of claim 1 further comprises:
a adapter cap threadedly connected to a thread means of said transmission adapter.

3. The apparatus of claim 2 further comprising:
a cap split ring sub abutting said proximal protuberance;
a cap split ring fitted into said adapter cap and configured to engage said cap split ring sub.

4. The apparatus of claim 3 wherein said transmission adapter is configured to connect to a rotary output of the down hole motor so that said socket profile is rotated which is transmitted to said center rod.

5. The apparatus of claim 4 further comprising an bearing adapter operatively connected to said center rod, and wherein said bearing adapter is configured to connect to an input of a bearing assembly in the down hole assembly.

6. The apparatus of claim 5 wherein said male post has a first end and a second end, wherein said second end has a spherical member operatively connected to said proximal protuberance and said first end is connected to said transmission adapter.

7. The apparatus of claim 6 wherein said female insert comprises: a cylindrical member with a convex surface configured to engage said spherical member of said male post.

8. The apparatus of claim 7 further comprising a second male post operatively configured to engage a second female insert positioned within said distal protuberance.

9. The apparatus of claim 8 further comprising:
a second adapter cap threadedly connected to a second thread means of said bearing adapter;
a second cap split ring sub abutting said proximal protuberance;
a second cap split ring fitted into said adapter cap and configured to engage said cap split ring sub.

10. An apparatus for transmitting torque to a down hole motor in a down hole drilling assembly comprising:
a center rod having a distal protuberance and a proximal protuberance, said proximal protuberance having a female insert therein;
a male post operatively configured to engage said female insert;
a transmission adapter having a first end connected to the down hole motor;
a socket formed within a second end of said transmission adapter and configured to receive said proximal protuberance;
an bearing adapter operatively connected to said center rod;
wherein said transmission adapter is configured to connect to an output of the down hole motor and said bearing adapter is configure to connect to an input of a bearing assembly in the down hole assembly.

11. The apparatus of claim 10 further comprising:
a adapter cap connected to a thread means located on said transmission adapter.

12. The apparatus of claim 11 further comprising:
a cap split ring sub abutting said proximal protuberance;
a cap split ring fitted into said adapter cap and configured to engage said cap split ring sub.

13. The apparatus of claim 12 wherein said male post has a first and a second end, wherein said second end has a spherical member operatively connected to said proximal protuberance and said first end is connected to said transmission adapter.

14. The apparatus of claim 13 wherein said female insert comprises: a cylindrical member with a convex surface configured to engage said protuberance of said male adapter post.

15. The apparatus of claim 14 further comprising a second male post operatively configured to engage a second female insert positioned within said distal protuberance.

16. The apparatus of claim 15 further comprising:
a second adapter cap threadedly connected to a second thread means of said bearing adapter;
a cap split ring sub abutting said proximal protuberance;
a cap split ring fitted into said adapter cap and configured to engage said cap split ring sub.

17. A method of drilling a well with a down hole motor comprising:
providing an apparatus in the well, wherein the apparatus comprises: a center rod having a distal protuberance and a proximal protuberance, a transmission adapter having a first end connected to the down hole motor; a socket formed within a second end of the transmission adapter and configured to receive the proximal protuberance; an bearing adapter operatively connected to the center rod, the bearing adapter having a bearing socket therein; wherein the transmission adapter is configured to connect to an output of the down hole motor and the bearing adapter is configured to connect to an input of a bearing assembly in the down hole assembly;
flowing a drilling fluid through the down hole motor which in turn rotates the output of the down hole motor, wherein the output is connected to the transmission adapter;
engaging the proximal protuberance of the center rod with the transmission socket in the transmission adapter;
engaging the distal protuberance of the center rod with the bearing socket in the bearing adapter;
rotating the center rod, the first protuberance and the second protuberance;
rotating the bearing assembly operatively associated with the bearing protuberance;
wherein the bearing assembly is attached to a drill bit so that the drill bit is rotated and the well is drilled.
